(19) United States
(12) Patent Application Publication
(10) Pub. No.: US 2020/0293196 A1
(43) Pub. Date: Sep. 17, 2020

(54) COMPRESSION OF PAGE OF DATA BLOCKS AND DATA INTEGRITY FIELDS FOR THE DATA BLOCKS FOR STORAGE IN STORAGE DEVICE

(71) Applicant: Hewlett Packard Enterprise Development LP, Houston, TX (US)

(72) Inventors: Roopesh Kumar Tamma, San Jose, CA (US); Srinivasa D. Murthy, Cupertino, CA (US)

(21) Appl. No.: 16/298,553

(22) Filed: Mar. 11, 2019

(51) Int. Cl. G06F 3/06

(52) U.S. Cl. CPC G06F 3/0608; G06F 3/0676; G06F 3/0679; G06F 3/0655

(57) ABSTRACT

A page of data blocks and data integrity fields (DIFs) for the data blocks to write to corresponding sectors of a storage device equal in number to the data blocks within the page is received. The data blocks and the DIFs are compressed, yielding compressed sector data. In response to a determination that a size of the compressed sector data is not greater than a size of the corresponding sectors, the compressed sector data is written to the sectors.

### BACKGROUND

Data is the lifeblood of many entities like business and governmental organizations, as well as individual users. Data is stored on storage devices, including magnetic disk drives and solid-state drives (SSDs). While storage devices have high reliability, they are not infallible. Data, even at the bit level, can be imperceptibly corrupted when stored on a storage device, which can result in lost or inaccurate information that the data reflects.

### BRIEF DESCRIPTION OF THE DRAWINGS

FIG. 1 is a flowchart of an example method for writing a page of data blocks and their data integrity fields (DIFs) to a storage device.

FIGS. 2A and 2B are diagrams illustrating example performance of the method of FIG. 1.

FIG. 3 is a flowchart of an example method for reading a page of data blocks that has been stored via the method of FIG. 1.

FIGS. 4A and 4B are diagrams illustrating example performance of the method of FIG. 3.

FIG. 5 is a diagram of an example system.

### DETAILED DESCRIPTION

As noted in the background, although storage devices typically have high reliability, data may nevertheless be corrupted. This means that the data written to a storage device differs when the data is subsequently read from the storage device. Corruption may occur due to a localized defect at which the data in question is being stored on the storage device, due to transient power and other fluctuations, and so on. Infrequent small-scale data corruption can be an insidious problem safeguards are not instituted to permit detection, if not correction, of such corruption.

One approach that first gained prominence in conjunction with storage devices, particularly magnetic disk drives, compatible with the small computer system interface (SCSI) standard is to add a data integrity field (DIF) that stores protection information (PI). Traditionally, storage devices have been formatted in 512-byte sectors, corresponding to 512-byte data blocks. Therefore, a memory page of N 512-byte data blocks when flushed from a cache is stored in corresponding N 512-byte sectors of a storage device. In a typical page, N may equal 32.

To safeguard against data corruption, a storage device employing DIFs is instead formatted to have 520-byte sectors. Each sector still is used to store a corresponding 512-byte data block. The remaining eight bytes of a sector are used to store a DIF including the PI. The eight bytes of PI within the DIF include a sixteen-bit guard tag, a sixteen-bit application or meta tag, and a 32-bit reference tag. The reference tag nominally contains information associated with a specific data block within some context, such as the lower four bytes of a logical block address (LBA), and the application or meta tag contains additional context information that is nominally held fixed within the context of an input/output (I/O) operation.

The guard tag, by comparison, stores a checksum value for the data of the data block written to the sector, such as a cyclic redundancy check (CRC) error-detecting code, or another type of error-correction code (ECC). Therefore, when a 512-byte data block is read from a 520-byte sector, a CRC code is calculated from the read data block and compared to the CRC code stored within the guard tag of the DIF of the sector. If the calculated CRC code differs from the stored CRC code, then the read data block is corrupt. That is, after the data block was stored within the sector, either data of the data block or data of the DIF (i.e., some data within the sector) became corrupted.

In this way, the DIF permits detection of corrupted data at the data block level. DIF usage has since its introduction seen adoption beyond SCSI magnetic disk drives. DIF can be used with other types of storage devices, for instance, such as SSDs. DIF can be used with other types of standards, such as the Internet SCSI (iSCSI) standard, the serial AT attachment (SATA) standard, the external SATA (eSATA) standard, the peripheral component internet (PCI) standard, and the PCI express (PCIe) standard.

However, usage of a DIF storing PI, regardless of the type of storage device or the storage device standard employed, presumes that a storage device can be formatted into 520-byte sectors. More generally, the usage of a DIF presumes that a storage device can be formatted into sectors of greater size than the data blocks that the sectors are to store, so that the sectors can also store PI within DIFs of the sectors. That is, to store x-byte data blocks while providing for y-byte DIFs, sectors typically have to be able to be formatted into (x+y)-byte sectors.

Lower-cost and older storage devices, though, may not be able to be formatted into sectors of a different size. For example, legacy storage devices may just be able to be formatted into 512-byte sectors, for storage of 512-byte blocks. While PI-storing DIFs may be added to such sectors by decreasing the size of the blocks that they store to make room for the DIFs, in practicality this is difficult if not impossible, because the rest of a computing system assumes a given size of data blocks. That is, a computing system that employs 512-byte data blocks within its memory addressing and caching schemes cannot simply be modified to use data blocks of a lesser size so that storage devices that have to be formatted into 512-byte sectors can also store DIFs.

When such lower-cost and older storage devices are used with systems mandating DIF usage—for instance, the upper levels of a computing system, including the operating system and/or the applications running on the operating system may employ DIF for end-to-end data integrity—the nominal “solution” is to discard DIFs when storing data blocks to storage device sectors. Then, when a data block is read from a sector, a DIF is generated on the fly to pass to the higher levels of the system in question. However, this approach does not actually provide for any data integrity at the storage device sector level, but rather just provides for compatibility with systems mandating DIF usage. This is because when a data block is read, the calculated DIF cannot be compared to a stored DIF; there is no stored DIF because at time of data block writing, the DIF was discarded.

Techniques described herein, by comparison, permit storage devices formatted into x-byte sectors to store both x-byte data blocks and y-byte DIFs for those data blocks. This means that a storage device formatted into 512-byte sectors can be used to store 512-byte data blocks and eight-byte DIFs to ensure data integrity at the storage device sector level. Generally, for a page of N x-byte data blocks, the N data blocks and their corresponding N y-byte DIFs are compressed to fit into N x-byte sectors, so that (x+y)-byte sectors are unnecessary while still providing for data integrity. More generally still, N x-byte data blocks and N y-byte DIFs are compressed to fit into N z-byte sectors, where z<(x+y), where each of N, x, y, and z is a positive integer. For example, the 32×512 bytes of data of 32 data blocks and the 32×8 bytes of PI for the 32 data blocks are compressed to fit into 32 512-byte sectors. In cases in which the N data blocks of a page and the N DIFs for the data blocks cannot be compressed to fit into the N sectors, other allowances are made, as described herein.

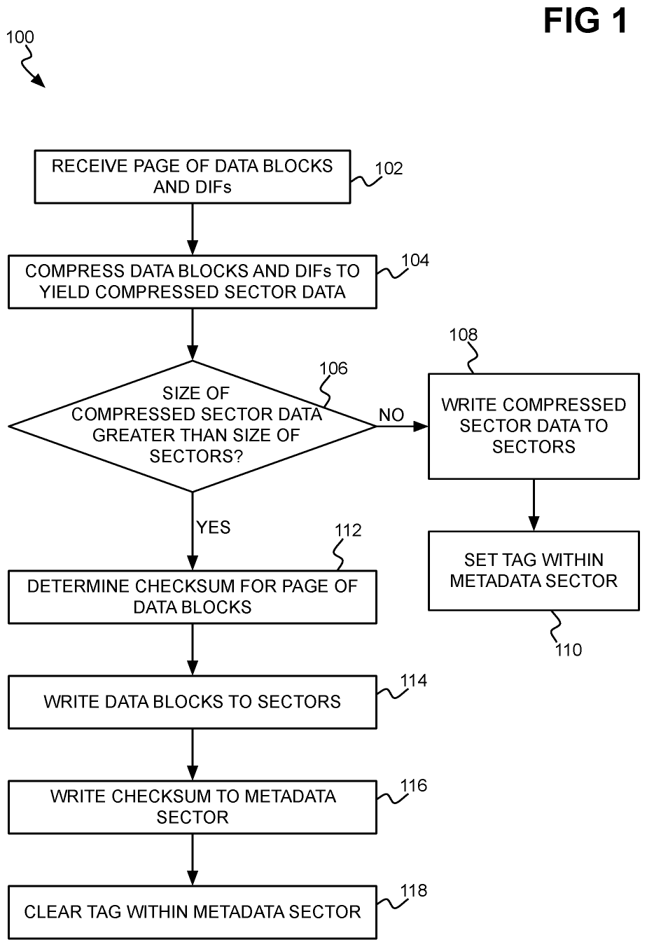

FIG. 1 shows an example method 100 for writing a page of data blocks and their DIFs to a storage device. The method 100 can be implemented as program code stored on a non-transitory computer-readable data storage medium. The program code can be executed by at least one processor, such as a controller like a host bus adapter (HBA). The controller may be part of the storage device, or may be external to the storage device.

The method 100 is described in relation to a page of 32 512-byte data blocks having eight-byte DIFs to be written to 32 512-byte sectors of a storage device. More generally, a page can be defined as a contiguous set of N x-byte data blocks. Each x-byte data block has a y-byte DIF storing PI. There are N z-byte sectors, where z<(x+y). In such examples, the number of sectors to store the data blocks (“N”) is equal to the number of data blocks (“N”). In some examples, z may be equal to x (i.e., the size of the data blocks may be the same as the size of the sectors).

A page of 32 512-byte data blocks and their eight-byte DIFs are received for writing to 32 sectors of the storage device (102). The controller or other processor performing the method 100 may receive the page of data blocks and the DIFs from a higher-level component of a computing system that includes the controller. For example, the controller performing the method 100 may be connected to at least one central processing unit (CPU) (or other processor(s)) that executes an operating system and application programs running on the operating system. The CPU and its associated components, like memory controllers, may support DIFs, and therefore provide this information along with the page of data blocks to the controller performing the method 100.

The data blocks and the DIFs are compressed to yield compressed sector data (104). The data blocks and the DIFs are compressed en masse (i.e., together), as a contiguous unit of 32*(512+8)=16,640 bytes to generate the compressed sector data. Different techniques can be used to compress the data blocks and the DIFs, such as the LZ4 compression algorithm, or the Deflate compression algorithm.

In the example described in relation to FIG. 1, the data sectors can store up to 32*512=16,384 bytes of data. If the size of the compressed sector data is no greater than the size of the data sectors as a whole (106), then the compressed sector data is written to the sectors (108). If the compressed sector data has fewer bytes than the 16,384 bytes of data storage provided by the data sectors, the extra space may be padded with null values.

There is not a one-to-one correspondence between the data blocks and their DIFs as compressed and the sectors to which the data blocks are written. That is, the data blocks and their DIFs are not compressed as individual data block-DIF pairs for storage into corresponding individual data sectors. Rather, the data blocks and their DIFs are compressed en masse to yield compressed sector data, which is then written to the data sectors in order. For example, the first 512 bytes of the compressed sector data is written to the first 512-byte sector, the next 512 bytes of the compressed sector data is written to the second 512-byte sector, and so on, until the compressed sector data has been completely written to the sectors. If the compressed sector data is sufficiently small in size, some sectors may not have any compressed sector data written to them.

The method 100 in the case in which the compressed sector data can fit into the sectors concludes with a tag being set within a metadata sector for the page of data blocks (110). The metadata sector can also be 512 bytes in length, and stores metadata for a number of pages of 512-byte data blocks. For example, if sixteen bytes of metadata are stored for each page, then a metadata sector stores metadata for 1,024 pages. The metadata sector may not be contiguous to the sectors to which the compressed sector data has been written. The tag is set to indicate that the data blocks of the page and their DIFs have been stored as compressed sector data within the sectors in question. The tag may be set to a particular value, such as logic one, for instance.

The compressed sector data into which the page of data blocks and their DIFs have been compressed may in the vast majority of cases be smaller or equal in size than the storage space afforded by the sectors corresponding to the data blocks. However, it cannot be guaranteed that this is always the case. It is at least theoretically possible that the compressed sector data is greater in size than the storage space that the sectors provide. If the compressed sector data is indeed greater in size in this respect, then the compressed sector data cannot be stored in the corresponding sectors per part 108, and a tag is not set, per part 110.

Rather, if the size of the compressed sector data is greater than the size of the sectors (106), then a checksum for the page of data blocks (i.e., the uncompressed version thereof received in part 102) may be determined (112). The checksum is calculated from the data of the data blocks, and does not consider or take into account the data blocks' DIFs, which are indeed discarded. The checksum is calculated for and from the data blocks en masse, and not for each individual data block. That is, there are not 32 checksums for the 32 data blocks, but rather one checksum for the page of data blocks. The checksum may be generated according to different techniques, such as the cyclic redundancy code (CRC) error-detection technique, or the SHA-256 hashing technique.

The data blocks in this case are written to the sectors (114). Each data block is written to a corresponding sector. That is, the first data block is written to the first sector, the second data block is written to the second sector, and so on. There is thus one-to-one correspondence in this case when writing the data blocks to the sectors. The sectors are at least equal in size to the data blocks so that each sector can store a corresponding data block (without its DIF, which is discarded as noted above).

The checksum for the page of data blocks as a whole is written to a metadata sector for the page (116). The checksum provides some data integrity, but not to the level of granularity that the PIs of the DIFs provide. That is, the checksum can be used to verify whether any data block within the page has been corrupted as stored on the storage device, but cannot specify the data block (or blocks) that has had its integrity compromised. This is because the checksum is calculated for the page of data blocks as a whole.

By comparison, the PIs of the DIFs provide data integrity for the data blocks as individually stored within the sectors. The PI of a DIF can be used to verify whether the corresponding data block has been corrupted as stored on the storage device. One data block may be corrupted as stored on the storage device, but another data block may not be. The DIFs thus provide true end-to-end data integrity at the data block level, even when stored in compressed form, whereas the checksum provides data integrity at the less granular page level.

Along with the checksum being written to the metadata sector, the tag for the page is cleared within the metadata sector (118). The tag can be cleared by resetting the tag to logic zero, for instance, or by clearing it in another manner. Clearing the tag indicates that the data blocks of the page have been stored uncompressed in one-to-one correspondence to the sectors, and that the DIFs have been discarded. Thus, in the case in which the compressed sector data (i.e., including the data blocks and the DIFs as compressed) cannot fit in the sectors, the method 100 reverts to parts 112, 114, 116, and 118, in which just the data blocks are stored in the sectors. To provide a minimum level of data integrity, a checksum for the page of data blocks as a whole can be calculated and stored, although the DIFs are discarded, precluding true end-to-end data integrity for the page at a data block level.

Nevertheless, as noted above, the vast majority of pages of data blocks and their DIFs are likely to fit as compressed sector data in the corresponding sectors. This is because the 32*(512+8)=16,640 bytes of a page of 32 512-byte data blocks having corresponding 8-byte DIFs just have to be compressed sufficiently to fit in 32*512=16,384 bytes of 32 512-byte sectors. As such, so long as the compression reduces the data blocks and the DIFs en masse by more than ˜1.5%—corresponding to the percentage (16,640−16,384)/16,640—end-to-end integrity at the data block level is assured via parts 108 and 110 of the method 100. The DIFs are discarded, in other words, just if the compression reduces the data blocks and the DIFs en masse by less than ˜1.5%, in which case the DIFs are discarded when performing parts 112, 114, 116, and 118 of the method 100.

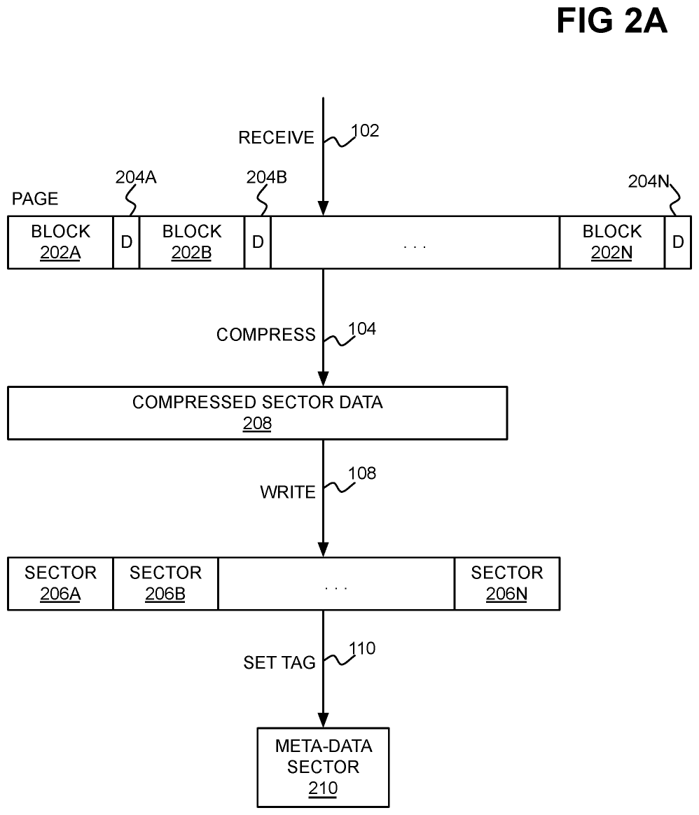

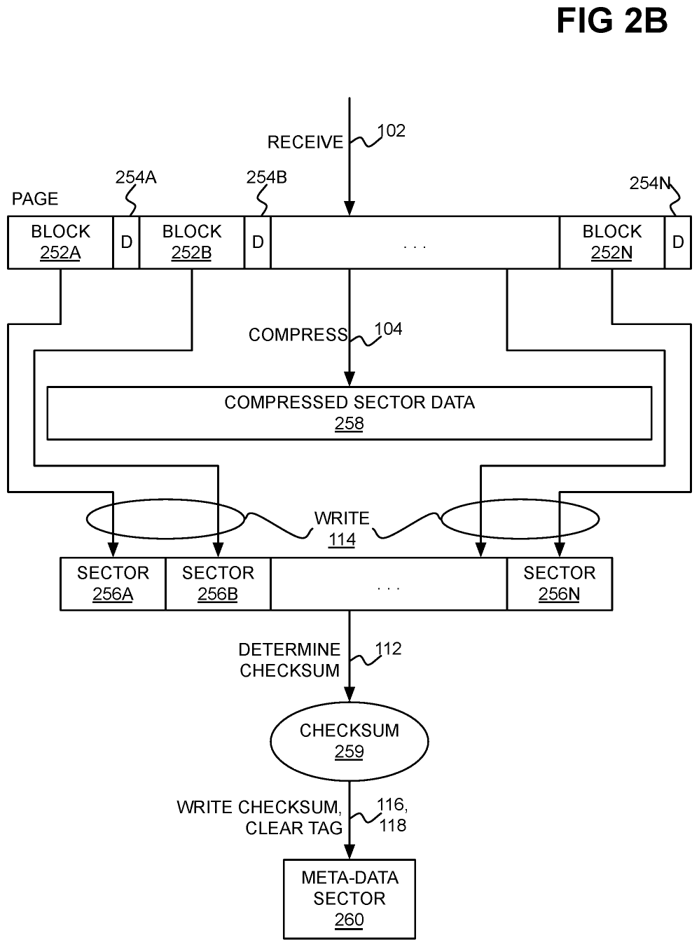

FIGS. 2A and 2B depict example performance of the method 100. In FIG. 2A, a page of N x-byte data blocks 202A, 202B, . . . , 202N, collectively referred to as the data blocks 202, is received (102), as are N y-byte DIFs 204A, 204B, . . . , 204N corresponding to the data blocks 202, and which are collectively referred to as the DIFs 204. The page of data blocks 202 and their DIFs 204 are to be written to N z-byte sectors 206A, 206B, . . . , 206N of a storage device, which are collectively referred to as the sectors 206, where z<(x+y) and where z may be equal to x.

The data blocks 202 and the DIFs 204 are compressed to generate compressed sector data 208 (104). In the example of FIG. 2A, the size of the compressed sector data 208 is no greater than the size of the sectors 206. That is, the size of the compressed sector data 208 is no greater than N*z. Therefore, the compressed sector data can fit within the sectors 206 and thus is written to the sectors 206 (108). A tag indicating that the sectors 206 store compressed sector data (and not uncompressed data blocks in one-to-one correspondence with the sectors 206) is also set within a metadata sector 210 (110).

In FIG. 2B, a page of N x-byte data blocks 252A, 252B, . . . , 252N, collectively referred to as the data blocks 252, is similarly received (102), as are N y-byte DIFs 254A, 254B, . . . , 254N corresponding to the data blocks 252, and which are collectively referred to as the DIFs 254. The page of data blocks 252 and their DIFs 254 are to be written to N z-byte sectors 256A, 256B, . . . , 256N of a storage device, which are collectively referred to as the sectors 256, where z<(x+y) and where z may be equal to x.

As in FIG. 2A, the data blocks 252 and the DIFs 254 are compressed in FIG. 2B to generate compressed sector data 258 (104). In the example of FIG. 2B, however, the size of the compressed sector data 258 is greater than the size of the sectors 206. That is, the size of the compressed sector data 258 is greater than N*z. Therefore, the compressed sector data cannot fit within the sectors 206, and thus is not written to the sectors.

Rather, in FIG. 2B, the data blocks 252 are written in uncompressed form to corresponding sectors 256, and their DIFs 254 discarded (114). For example, the data block 252A is written to the sector 256A, the data block 252B is written to the sector 256B, and the data block 256A is written to the sector 256N. (Note that such writing is in contradistinction to that in FIG. 2A, where the compressed sector data 208 was written en masse to the sectors 206 without one-to-one writing correspondence between the data blocks 202 and the sectors 206.)

A checksum 259 also can be determined based on the (uncompressed) data blocks 252 (and not based on the DIFs 254 for the data blocks 252) in FIG. 2B (112). The checksum 259 is written a metadata sector 260 (116). A tag is further cleared or reset within the metadata sector 260 (118), indicating that the sectors 256 store a page of uncompressed data blocks 252, as opposed to compressed sector data 258 of the data blocks 252 and their DIFs 254.

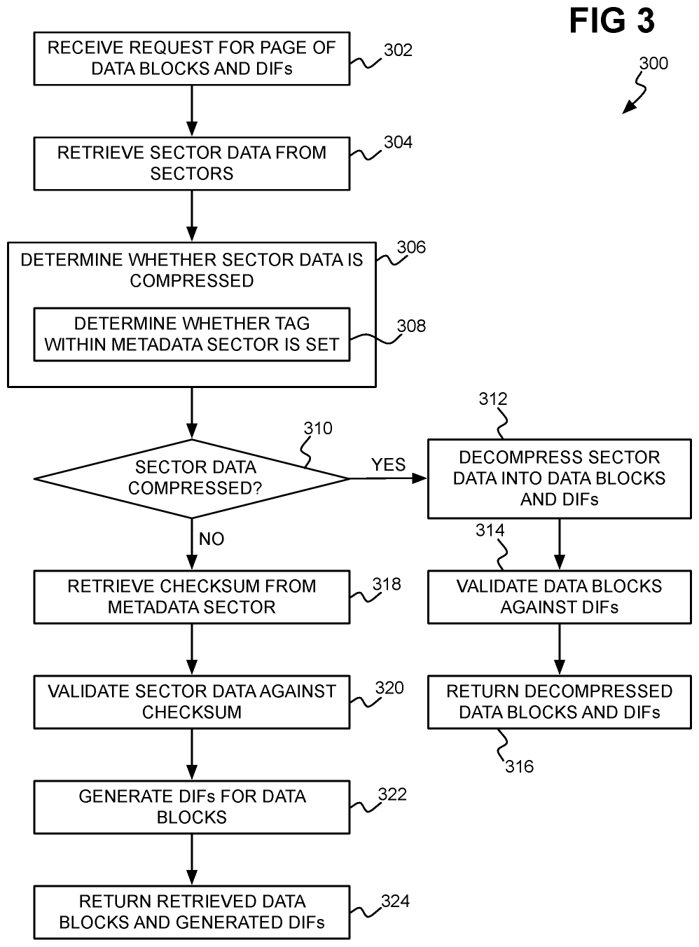

FIG. 3 shows an example method 300 for reading a page of data blocks that has been written to a storage device via the method 100. Like the method 100, the method 300 can be implemented as program code stored on a non-transitory computer-readable storage medium. The program code can be executed by a processor, such as a controller like an HBA. The controller may be part of the storage device, or external to the device.

The method 300 is described in relation to a page of 32 512-byte data blocks having eight-byte DIFs to be written to 32 512-byte sectors of a storage device. As noted above, however, more generally, a page can be defined as a contiguous set of N x-byte data blocks. Each x-byte data block has a y-byte DIF storing PI. There are N z-byte sectors, where z<(x+y); that is, the number of sectors to store the data blocks is equal to the number of data blocks. For example, z may be equal to x (i.e., the data blocks and the sectors may be equal in length).

A request is received for a page of 32 512-byte data blocks and their eight-byte DIFs (302). The controller or other processor performing the method 300 may receive the request from a higher-level component of a computing system that includes the controller, such as a CPU or a component associated with the CPU, like a memory controller. The DIFs are requested in addition to the page of data blocks, which can provide for end-to-end data integrity from the storage device to the higher-level components of the system.

Sector data from the 32 512-byte sectors corresponding to the data blocks of the requested page is retrieved (304). The sector data may store the data blocks and their DIFs in compressed form when parts 108 and 110 of the method 100 were previously performed to store the data blocks on the storage device. The sector data may alternatively store just the data blocks in uncompressed form, and not the DIFs, when parts 112, 114, 116, and 118 of the method were previously performed to store the data blocks on the storage device.

Therefore, the method 300 includes determining whether the retrieved sector data is compressed or not (306). That is, the method 300 determines whether the retrieved sector data stores the data blocks and their DIFs in compressed form, or whether the retrieved sector data stores just the data blocks (and not their DIFs) in uncompressed form. This determination can be achieved by determining whether the tag within a metadata sector for the page of data blocks is set or cleared (308). As noted above, the tag for the page is set within the metadata sector in question if the blocks of the page and their DIFs have been stored in compressed form within the sectors in question, and is cleared if just the blocks are stored, in uncompressed form, within the sectors.

If the retrieved sector data is compressed (310), then the sector data is decompressed into the data blocks and their DIFs (312). The decompression technique employed in part 312 corresponds to the compression technique previously used to compress the data blocks and the DIFs in part 104 of the method 100. As noted above, the data blocks and the DIFs are not compressed on an individual data block-DIF pair basis, but rather the data blocks and the DIFs are compressed en masse to yield the (compressed) sector data that is stored in the sectors.

Once the data blocks and the DIFs have been decompressed from the retrieved sector data, each data block is validated against its corresponding DIF (314). The validation of the data blocks against their DIFs ensures on a block-by-block basis that the data blocks have not been corrupted after storage on the storage device. For the data blocks of such a page that are stored along with their DIFs in compressed form on corresponding sectors of the storage device, data integrity is therefore provided at the granular data block level on the storage device. After validation, the data blocks and the DIFs that have been decompressed from the compressed sector data are returned in response to the received request (316).

By comparison, if the retrieved sector data is not compressed (310), then the sector data stores just the data blocks (and not their DIFs) in uncompressed form, with each sector storing a corresponding data block. The checksum for the page of data blocks that was previously generated in part 112 of the method 100 is retrieved from the metadata sector (318). The retrieved sector data (i.e., the data blocks stored in uncompressed form on the sectors in one-to-one correspondence between the data blocks and the sectors) is validated against the retrieved checksum (320).

Specifically, the method 300 can itself generate the checksum from the sector data that has been retrieved, using the same approach that was used to generate the retrieved checksum in part 112 of the method 100. As such, the method 300 generates the checksum from the sector data as a whole—i.e., from the retrieved data blocks en masse—and not for each individual data block. This checksum that the method 300 generates is compared against the checksum that the method 300 retrieved from the metadata sector.

If the two checksum match, then no data block of the page has been corrupted after the data blocks were stored in uncompressed form on the sectors in question in part 114 of the method 100. If the checksum differ, then one or more data blocks of the page became corrupted after the blocks were stored. Such validation ensures data integrity at the less granular page level on the storage device, as opposed to on the more granular data block level that can be provided when the DIFs are stored along with the data blocks. That is, if the checksums differ, it is known that one or more data blocks of the page have been corrupted, but the particular data block or blocks that are corrupted cannot be particularly identified.

Once the data blocks have been validated against the checksum, the DIFs for the data blocks are generated (322). The DIF for a data block is generated from the data of the data block, without consideration of or taking into account the data of any other data block. The DIFs are generated in accordance with the PI protocol or standard governing the end-to-end integrity across the computing system. That is, the DIFs are generated in the same manner that other components of the computing system generate the DIFs.

The generated DIFs can be interleaved within the retrieved data blocks (i.e., within the retrieved sector data), and the page of data blocks and their DIFs returned responsive to the received request (324). The generation and return of the DIFs along with the data blocks themselves provides for compatibility with the computing system, in which DIF usage is mandated (and in which DIFs are expected by the component that issued the request received in part 302). Therefore, although data integrity is not actually provided at the granular block level on the storage device for data blocks stored in uncompressed form on their corresponding sectors of the storage device, DIF compatibility is nevertheless maintained. This tradeoff can be considered acceptable, because the vast majority of pages of data blocks will in all likelihood be stored in compressed form along with their DIFs, as noted above.

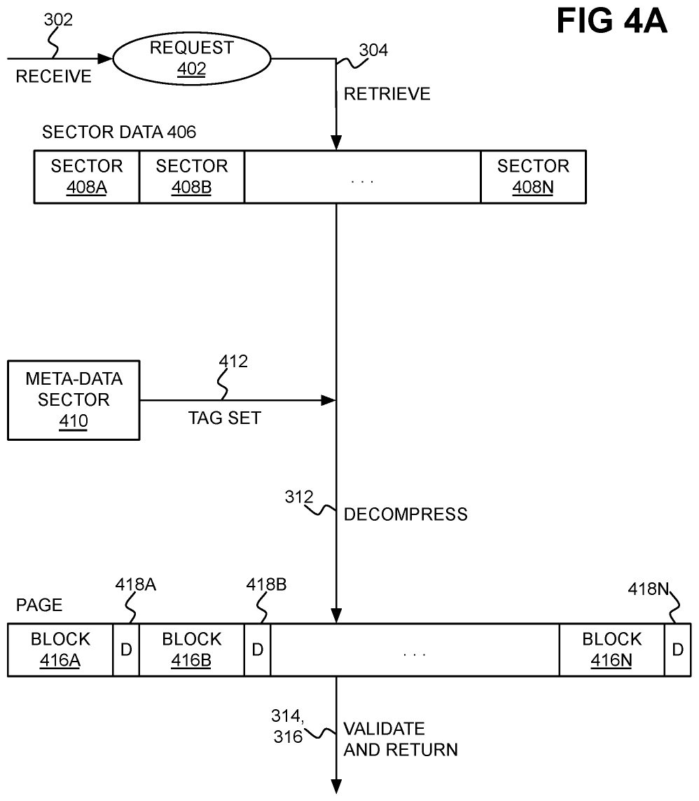

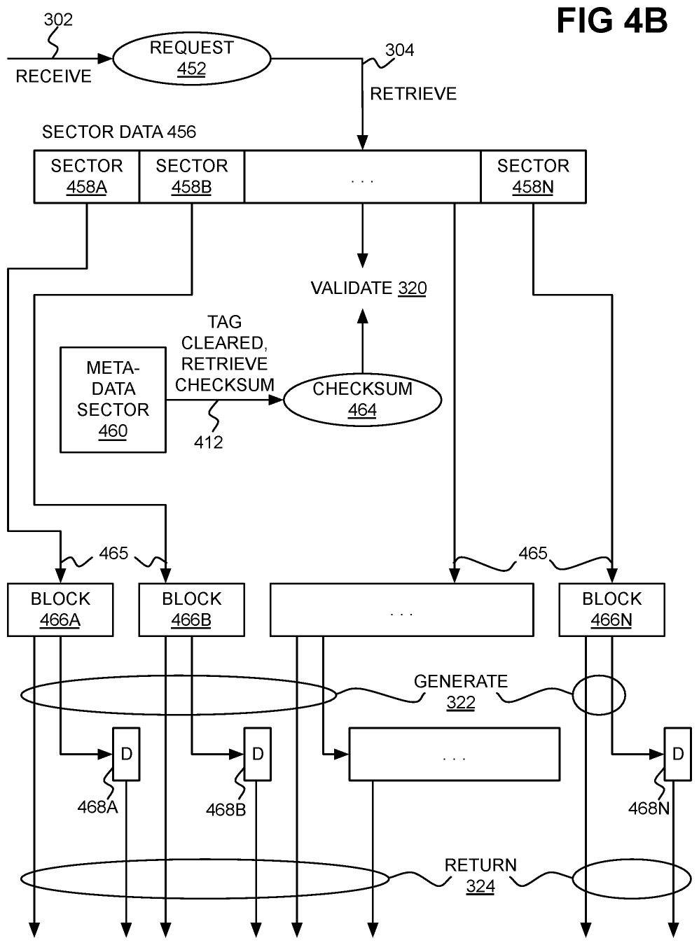

FIGS. 4A and 4B depict example performance of the method 300. In FIG. 4A, a request 402 for a page of N x-byte data blocks 416A, 416B, . . . , 416N, collectively referred to as the data blocks 416, and their y-byte DIFs 418A, 418B, . . . , 418N, collectively referred to as the DIFs 418, is received (302). In response, sector data 406 from N x-byte sectors 408A, 408B, . . . , 408N, collectively referred to as the sectors 408, is retrieved (304).

In the example of FIG. 4A, the sector data 406 stores the page of data blocks 416 and the DIFs 418 in compressed form. That is, the sector data 406 is compressed sector data. As such, a tag within a metadata sector 410 for the page of data blocks 416 was previously set (412) when the sector data 406 was written to the sectors 408.

The sector data 406 retrieved from the sectors 408 is therefore decompressed into the requested data blocks 416 and their DIFs 418 (312). The decompressed data blocks 416 are individually validated against their corresponding DIFs 418 (314), and then the page of data blocks 416 and the DIFs 418 are returned responsive to the received request 402 (316). The example of FIG. 4A thus particularly illustrates performance of the parts 312, 314, and 316 of the method 300.

In FIG. 4B, a request 452 for a page of N x-byte data blocks 466A, 466B, . . . , 466N, collectively referred to as the data blocks 466, and their y-byte DIFs 468A, 468B, . . . 468N, collectively referred to as the DIFs 468, is similarly received (302). In response, sector data 456 from N x-byte sectors 458A, 458B, . . . , 458N, collectively referred to as the sectors 458, is retrieved (304).

In the example of FIG. 4B, the sector data 456 stores the page of data blocks 466 (and not the DIFs) 418 in uncompressed form, in one-to-one sector-to-data block correspondence. Each individual sector 458 of the sector data 456 corresponds to one of the data blocks 466, as indicated by the arrows 465 in FIG. 4B. For instance, the sector data 456 of the sector 458A is the data block 466A, the sector data 456 of the sector 458B is the data block 466B, and the sector data 456 of the sector 458N is the data block 466N.

The sector data 406 is thus uncompressed sector data. As such, a tag within a metadata sector 460 for the page of data blocks 466 was previously cleared (462) when the sector data 456 was written to the sectors 458. A checksum 464 that was previously written to the metadata sector 460 when the sector data 456 was written to the sectors 458 is retrieved (318). The sector data 456 is validated against the retrieved checksum 464 (320). That is, as noted above, another checksum is generated from the sector data 456 as a whole, as retrieved from the sectors 458, and not on an individual data block or sector basis. This generated checksum is compared against the retrieved checksum 464 to verify that the two checksum are identical.

Once the sector data 456 has been validated against the checksum 464, the DIFs 468 are generated from the data blocks 466 on a data block-by-data block basis (322). That is, the DIF 468A is generated from and for the data block 466A, the DIF 468B is generated from and for the data block 466B, the DIF 468N is generated from and for the data block 466N, and so on. The retrieved data blocks 466 and the generated DIFs 468 are returned responsive to the received request 452 (324). The example of FIG. 4B thus particularly illustrates performance of the parts 318, 320, 322, and 324 of the method 300.

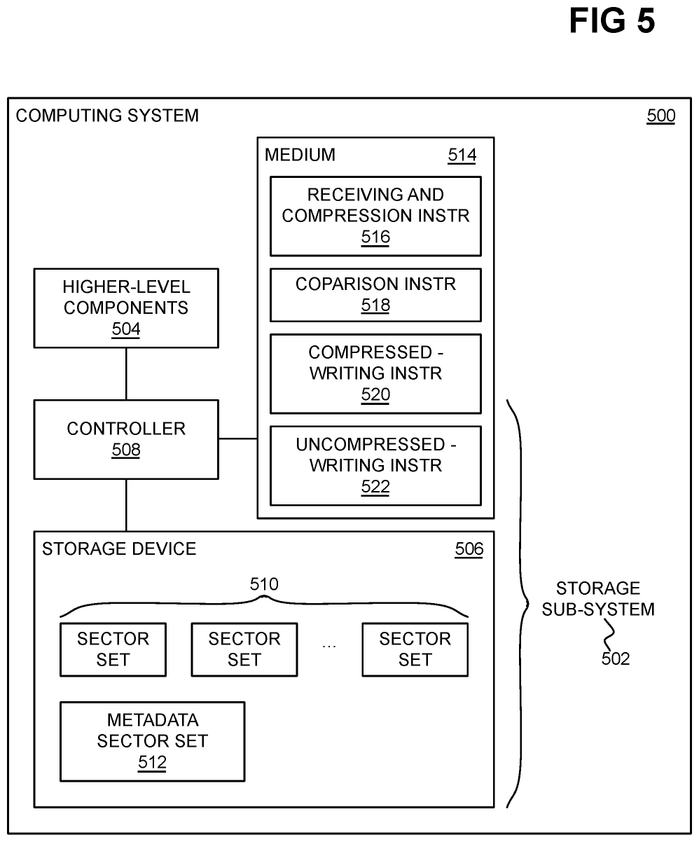

FIG. 5 shows an example computing system 500. The computing system 500 includes a storage sub-system 502, which may also be referred to as a storage system. The computing system 500 further includes higher-level hardware components 504. The higher hardware components 504 can include processors and other hardware components, such as memory controllers. The computing system 500 can have end-to-end data integrity on primarily a data block basis, via the higher-level components 504 providing DIFs having PIs for data blocks, and via the storage sub-system 502 similarly providing such DIFs for the vast majority of data blocks consistent with the techniques that have been described.

The storage sub-system 502 includes a storage device 506 and a hardware controller 508. As depicted in FIG. 5, the controller 508 can be separate from the storage device 506, but in another implementation the controller 508 can be part of the storage device 506. The storage device 506 can be a magnetic hard disk drive, an SSD, or another type of storage device.

The storage device 506 includes sector sets 510 and a metadata sector set 512. The sector sets 510 each correspond to a page of N x-byte data blocks, where the data blocks have corresponding y-byte DIFs. Each sector set 510 specifically includes N z-byte sectors. As noted above z<(x+y), and z may be equal to x. As examples of sector sets 510, the sectors 206 of FIG. 2A for the page of data blocks 202 having DIFs 204 constitute a sector set, as do the sectors 256 of FIG. 2B for the page of data blocks 252 having DIFs 254. Likewise, the sectors 408 of FIG. 4A for the page of data blocks 416 having DIFs 418 constitute a sector set, as do the sectors 458 of FIG. 4B for the page of data blocks 466 having DIFs 468.

The metadata sector set 512 includes a number of metadata sectors, such as the metadata sectors 210, 260, 410, and 460 of FIGS. 2A, 2B, 4A, and 4B, respectively. Each metadata sector can also be z bytes in length, such as 520 bytes in length. Each metadata sector stores metadata for a number of pages of data blocks. For example, if each metadata sector stores sixteen bytes of metadata for each page, and if each metadata sector is 512 bytes in length, then each metadata sector can store metadata for 1,024 pages.

The controller 508 provides for data integrity of the data blocks stored within the sector sets 510 in accordance with the techniques that have been described herein. As such, the controller 508 can perform the method 100 of FIG. 1 and the method 300 of FIG. 3 that have been described. For example, the controller 508 can execute instructions stored on a non-transitory computer-readable data storage medium 514 of the computing system 500, to perform the methods 100 and 300.

As one example, the instructions can include instructions 516, 518, 520, and 522. The instructions 516 are receiving and compression instructions to perform parts 102 and 104 of the method 100. The instructions 518 are comparison instructions to perform part 106 of the method 100. The instructions 520 are compressed-writing instructions to perform parts 108 and 110 of the method 100. The instructions 522 are uncompressed-writing instructions to perform parts 112, 114, 116, and 118 of the method 100.

In all likelihood, for the vast majority of pages of data blocks, the controller 508 provides data integrity at a granular data block level, using DIFs. This is the case even though the sectors of the sector sets 510 are smaller in size than the corresponding sizes of the data blocks and their DIFs. For a likely much smaller number of pages of data blocks, the controller 508 still provides data integrity, but at a coarser page level.

The techniques that have been described herein thus permit lower cost and other storage devices that cannot be formatted to have 520-byte sectors—and instead have just 512-byte sectors—to nevertheless be used in systems providing data integrity for 512-byte data blocks via eight-byte DIFs. If a page of data blocks and their corresponding DIFs can be compressed to fit into sectors equal in number to the number of data blocks, then the compressed data blocks and compressed DIFs are stored in the sectors. Otherwise, the uncompressed data blocks (and not their DIFs) are stored in the sectors in one-to-one correspondence, with the DIFs discarded, and a checksum for the page of data blocks as a whole may be stored in a metadata sector.

We claim:

1. A non-transitory computer-readable data storage medium comprising program code executable by a processor to:
receive a page of data blocks and data integrity fields (DIFs) for the data blocks to write to a corresponding plurality of sectors of a storage device equal in number to the data blocks within the page;
compress the data blocks and the DIFs, yielding compressed sector data; and
in response to determining that a size of the compressed sector data is not greater than a size of the corresponding plurality of sectors, write the compressed sector data to the sectors,
wherein the size of each of the data blocks is the same as the size of each of the sectors.

2. The non-transitory computer-readable data storage medium of claim 1, wherein the program code is executable by the processor to further:
set a tag within a metadata sector of the storage device, the set tag corresponding to the page and denoting that the data blocks of the page and the DIFs for the data blocks have been stored within the sectors as the compressed sector data.

3. The non-transitory computer-readable data storage medium of claim 1, wherein the program code is executable by the processor to further:
in response to determining that a size of the compressed sector data is greater than the size of the corresponding plurality of sectors, determine a checksum for the page;
write the data blocks to the sectors of the storage device; and
write the checksum to a metadata sector of the storage device.

4. The non-transitory computer-readable data storage medium of claim 3, wherein the program code is executable by the processor to further:
clear a tag within the metadata sector, the cleared tag corresponding to the page and denoting that the data blocks of the page are stored uncompressed within the sectors and that the DIFs for the data blocks have been discarded.

5. The non-transitory computer-readable data storage medium of claim 1, wherein the size of each of the data blocks and the size of each of the sectors is 512 bytes.

6. A method comprising:
receiving, by a processor, a request for a page of data blocks and data integrity fields (DIFs) for the data blocks;
retrieving, by the processor, sector data from a plurality of sectors of a storage device, the sectors equal in number to the data blocks within the page; and
in response to determining that the sector data is compressed, decompressing, by the processor, the sector data into the data blocks and the DIFs; and
returning, by the processor, the decompressed data blocks and the decompressed DIFs,
wherein the size of each of the data blocks is the same as the size of each of the sectors.

7. The method of claim 6, further comprising:
prior to returning the decompressed data blocks and the decompressed DIFs, validating, by the processor, the decompressed data blocks against the decompressed DIFs.

8. The method of claim 6, wherein determining that the sector data is compressed comprises determining that a tag corresponding to the page within a metadata sector of the storage device is set, the tag indicating whether the sector data is compressed or uncompressed.

9. The method of claim 6, further comprising:
in response to determining that the sector data is uncompressed, returning, by the processor, the sector data as the requested data blocks;
generating, by the processor, the requested DIFs for the data blocks from the sector data; and
returning, by the processor, the generated DIFs for the data blocks.

10. The method of claim 9, further comprising:
prior to returning the sector data as the data blocks, retrieving, by the processor, a checksum for the sector data from a metadata sector of the storage device; and
validating, by the processor, the sector data against the retrieved checksum.

11. The method of claim 9, wherein determining that the sector data is uncompressed comprises determining that a tag corresponding to the page within a metadata sector of the storage device is not set, the tag corresponding to the sector and indicating whether the sector data is compressed or uncompressed.

12. The method of claim 6, wherein the data blocks and the sectors are each equal to 512 bytes in length, and the DIFs are each equal to eight bytes in length.

13. A storage system comprising:
a storage device having a plurality of sector sets corresponding to a plurality of pages of data blocks, each sector set having a number of sectors equal to a number of the data blocks in each page; and
a controller to:
compress a first page of data blocks and data integrity fields (DIF) for the first page of data blocks, yielding first compressed sector data;
determine that the first compressed sector data has a size no greater than a size of a first sector set corresponding to the first page; and
write the first compressed sector data to the sectors of the first sector set,
wherein the size of each of the data blocks is the same as the size of each of the sectors.

14. The storage system of claim 13, wherein the controller is further to:
compress a second page of data blocks and DIFs for the second page of data blocks, yielding second compressed sector data;
determine that the second compressed sector data has a size greater than a size of a second sector set corresponding to the second page;
write each data block of the second page to a corresponding sector of the second sector set.

15. The storage system of claim 14, wherein the storage device has a metadata sector set including a plurality of metadata sectors storing metadata for the pages of data blocks.

16. The storage system of claim 15, wherein the controller is further to:
determine a checksum for the second page of data blocks; and
write the checksum to a metadata sector of storing the metadata for the second page.

17. The storage system of claim 16, wherein the controller is further to:
clear a tag for the second page within the metadata sector storing the metadata for the second page, the cleared tag denoting that the second page is stored uncompressed within the second sector set and that the DIFs for the data blocks of the second page have been discarded.

18. The storage system of claim 15, wherein the controller is further to:
set a tag for the first page within a metadata sector storing the metadata for the first page, the set tag denoting that the first page and the DIFs for the data blocks of the first page have been stored within the first sector set as the first compressed sector data.

19. The storage system of claim 13, wherein the data blocks and the sectors are each equal in length.

20. The storage system of claim 19, wherein the data blocks and the sectors are each equal to 512 bytes in length, and the DIFs are each equal to eight bytes in length.
